(19) United States
(12) Patent Application Publication
(10) Pub. No.: US 2025/0121885 A1
(43) Pub. Date: Apr. 17, 2025

(54) VEHICLE

(71) Applicant: HONDA MOTOR CO., LTD., Tokyo (JP)

(72) Inventors: Naoki TANI, Tokyo (JP); Yasuhiko Kawase, Tokyo (JP); Yoshiro Ishinabe, Tokyo (JP)

(73) Assignee: HONDA MOTOR CO., LTD., Tokyo (JP)

(21) Appl. No.: 18/912,661

(22) Filed: Oct. 11, 2024

(30) Foreign Application Priority Data
Oct. 13, 2023 (JP) 2023-177443

(51) Int. Cl. B62D 21/03; B60L 50/60; B60N 2/07; B62D 25/02; B62D 25/20; H01M 50/242; H01M 50/249; H01M 50/262; H01M 50/271

(52) U.S. Cl. CPC B62D 21/03; B60L 50/66; B60N 2/0735; B62D 25/025; B62D 25/20; H01M 50/242; H01M 50/249; H01M 50/262; H01M 50/271; H01M 2220/20

(57) ABSTRACT

A vehicle includes: a vehicle body frame; and a battery pack including a battery and a battery case in which the battery is accommodated and attached to the vehicle body frame. The vehicle body frame includes a pair of side frames extending along a front-rear direction of the vehicle and arranged on both sides in a left-right direction of the vehicle. The battery pack is fixed to the pair of side frames. The battery case includes a case main body on which the battery is disposed, and a battery cover covering the case main body from above and having an upper surface forming a floor panel of the vehicle. The battery cover is integrally provided with a cross member portion extending in the left-right direction and having an upper portion on which a seat configured to allow a passenger to sit on is mounted.

This application is based upon and claims the benefit of priority from prior Japanese patent application No. 2023-177443, filed on Oct. 13, 2023, the entire contents of which are incorporated herein by reference.

### TECHNICAL FIELD

The present disclosure relates to a vehicle in which a battery pack is attached to a vehicle body frame.

### BACKGROUND ART

In recent years, researches and developments have been conducted on a secondary battery which contributes to improvement in energy efficiency in order to allow more people to have access to affordable, reliable, sustainable and advanced energy.

For example, WO2022/251284 describes a vehicle on which a battery pack in which a plurality of battery modules are accommodated in a housing is mounted. In Patent Literature 1, the battery pack is fixed to a lower portion of a vehicle body frame, and an upper surface of the housing constitutes a part of a floor of the vehicle.

### SUMMARY

WO2022/251284 describes a configuration in which a seat attachment member is provided on the upper surface of the housing, but there is room for improvement in order to sufficiently ensure rigidity of the housing against a load from a seat.

Aspects of embodiments of the present disclosure relates to providing a vehicle in which a seat is directly mounted on a battery cover of a battery pack and rigidity of the battery cover against a load from the seat may be sufficiently ensured. This further contributes to the improvement in energy efficiency.

According to an aspect of the present disclosure, there is provided a vehicle including:
a vehicle body frame; and
a battery pack including a battery and a battery case in which the battery is accommodated and attached to the vehicle body frame, in which
the vehicle body frame includes a pair of side frames extending along a front-rear direction of the vehicle and arranged on both sides in a left-right direction of the vehicle,
the battery pack is fixed to the pair of side frames,
the battery case includes
   a case main body on which the battery is disposed, and
   a battery cover covering the case main body from above and having an upper surface forming a floor panel of the vehicle, and
the battery cover is integrally provided with a cross member portion extending in the left-right direction and having an upper portion on which a seat configured to allow a passenger to sit on is mounted.

According to the present disclosure, the seat is directly mounted on the battery cover, and rigidity of the battery cover against a load from the seat may be sufficiently ensured.

### BRIEF DESCRIPTION OF DRAWINGS

Exemplary embodiment(s) of the present invention will be described in detail based on the following figures, wherein:

FIG. 1 is an exploded perspective view of a vehicle V according to an embodiment of the present disclosure;

FIG. 2 is an external perspective view of a battery pack 20 fixed to a pair of side frames 5, and seats 7L and 7R attached to a battery cover 40A of the battery pack 20;

FIG. 3 is an exploded perspective view of a battery case 23;

FIG. 4 is a top view of the battery pack 20;

FIG. 5 is an external perspective view of the battery pack 20 fixed to side sills 4 and the side frames 5;

FIG. 6 is an enlarged perspective view of extension members 45 attached to cross member portions 42; and

FIG. 7 is a cross-sectional view taken along a line VII-VII in FIG. 5.

### DESCRIPTION OF EMBODIMENTS

Hereinafter, a vehicle according to an embodiment of the present disclosure will be described with reference to the accompanying drawings. The drawings are to be viewed in the direction of reference signs, and in the following description, front-rear, left-right, and upper-lower directions are referred to as directions seen from a driver, and in the drawings, a front side of the vehicle is shown as Fr, a rear side is shown as Rr, a left side is shown as L, a right side is shown as R, an upper side is shown as U, and a lower side is shown as D. The left-right direction may also be referred to as a vehicle width direction.

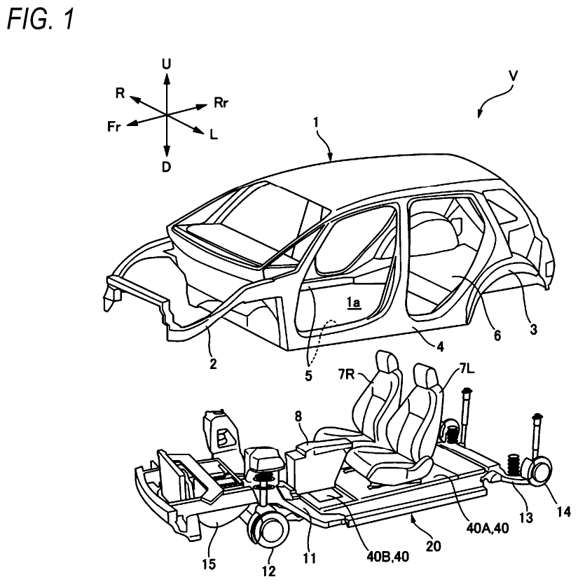

As shown in FIG. 1, a vehicle V includes a vehicle body frame 1 that forms a framework of the vehicle V, a front suspension 11 disposed at a front portion of the vehicle V, left and right front wheels 12 supported by the front suspension 11, a rear suspension 13 disposed at a rear portion of the vehicle V, left and right rear wheels 14 supported by the rear suspension 13, a motor 15 disposed at the front portion of the vehicle V and serving as a power source of the vehicle V, and a battery pack 20 attached to the vehicle body frame 1. The vehicle V is, for example, an electric automobile that supplies electric power stored in the battery pack to the motor 15 and travels by power of the motor 15. The vehicle V may be a hybrid vehicle that further includes an engine and may travel by power of the engine and/or the motor 15.

The vehicle body frame 1 includes a front frame 2 provided in front of the battery pack 20, a rear frame 3 provided behind the battery pack 20, and side sills 4 connected to the front frame 2 and the rear frame 3. The front frame 2 forms a power chamber that accommodates a power source such as the motor 15. The rear frame 3 is disposed outside a rear floor panel 6 forming a floor portion of a luggage compartment in a left-right direction, and extends in a front-rear direction.

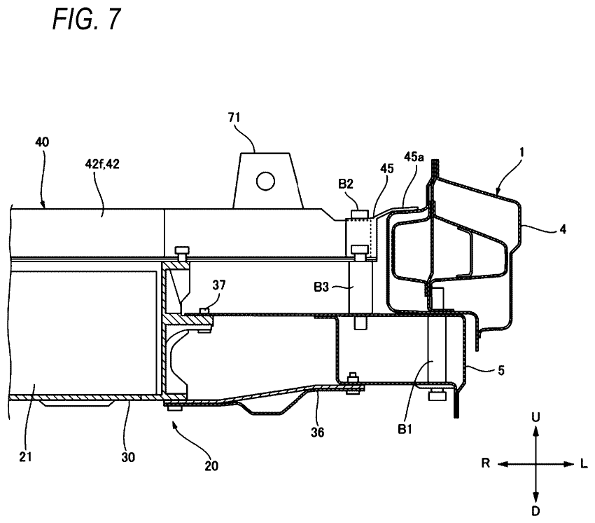

The vehicle body frame 1 further includes a pair of side frames 5 fixed to lower portions of the side sills 4 and provided on both sides of the battery pack 20 in the left-right direction. The side frame 5 is fixed to the side sill 4 by a fastening member B1 (see FIG. 7) such as a bolt.

An opening 1a is provided at a lower portion of the vehicle body frame 1. The opening 1a is provided in front of the rear floor panel 6 and at an inside of the side sill 4 and the side frame 5 in a vehicle width direction. The battery pack 20 is attached to the opening 1a.

The front suspension 11 is provided in front of the battery pack 20 and is fixed to the vehicle body frame 1. The front wheel 12 is supported by the vehicle body frame 1 via the front suspension 11.

The rear suspension 13 is provided behind the battery pack 20 and is fixed to the vehicle body frame 1. The rear wheel 14 is supported by the vehicle body frame 1 via the rear suspension 13.

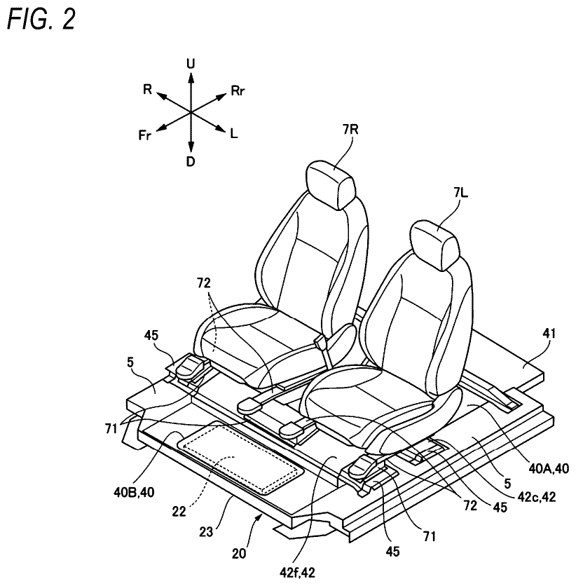

As shown in FIGS. 2 to 4, the battery pack 20 includes a battery 21 (see FIG. 7) including a plurality of cells, an auxiliary device 22 electrically connected to the battery 21, and a battery case 23 accommodating the battery 21 and the auxiliary device 22.

The battery 21 is, for example, an all-solid-state battery. Although not illustrated, each cell of the battery 21 which is an all-solid-state battery includes a positive electrode, a negative electrode, and a solid electrolyte disposed between the positive electrode and the negative electrode, which are sealed and packaged in an exterior body such as a laminate film. The battery 21 performs charging and discharging by transferring lithium ions between the positive electrode and the negative electrode via the solid electrolyte.

The solid electrolyte is not particularly limited as long as having lithium ion conductivity and an insulating property, and materials generally used for all-solid-state lithium ion batteries may be used. Examples of the solid electrolyte include inorganic solid electrolytes such as sulfide solid electrolyte materials, oxide solid electrolyte materials, and lithium-containing salts, and polymer-based solid electrolytes such as polyethylene oxide. A form of the solid electrolyte material is not particularly limited, and may be, for example, a particulate form.

The auxiliary device 22 includes, for example, a junction box on which wiring components through which a charging current and a discharging current of the battery 21 flow are mounted. The auxiliary device 22 is electrically connected to the battery 21 via, for example, a bus bar (not shown).

The battery case 23 includes a case main body 30 which is shaped in a bottomed container, and a case cover 40 covering the case main body 30 from above.

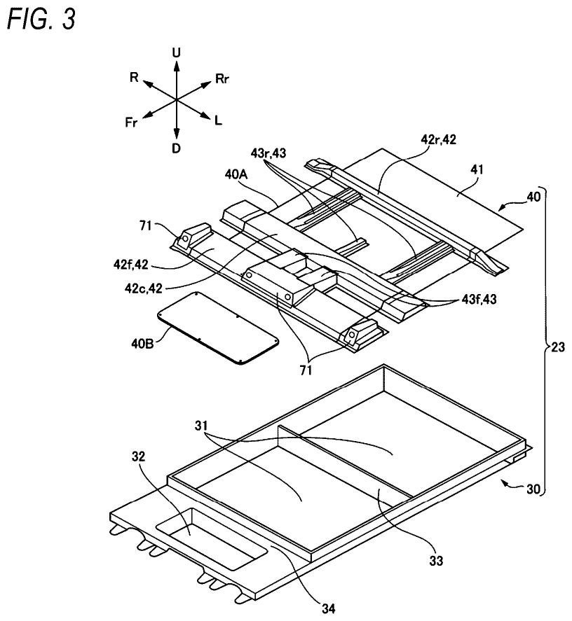

As shown in FIG. 3, the case main body 30 includes a battery accommodating chamber 31 in which the battery 21 is disposed, and an auxiliary device accommodating chamber 32 in which the auxiliary device 22 is disposed. The battery accommodating chamber 31 is divided into two chambers by a central wall portion 33 extending in the left-right direction, and the battery 21 is accommodated in each battery accommodating chamber 31. The auxiliary device accommodating chamber 32 is provided on a front portion of the case main body 30, and is provided in front of the battery accommodating chamber 31 across a partition wall portion 34.

The case cover 40 includes a battery cover 40A covering the battery accommodating chamber 31 from above, and an auxiliary device cover 40B covering the auxiliary device accommodating chamber 32 from above. As shown in FIGS. 1 and 2, an upper surface 41 of the case cover 40 (that is, an upper surface of the battery cover 40A and an upper surface of the auxiliary device cover 40B) constitutes a floor panel of the vehicle V. In other words, the floor panel and the case cover 40 are integrated and constituted by a single component. Accordingly, it is not necessary to provide the floor panel separately from the case cover 40, and thus a weight of the vehicle V may be reduced.

Since the auxiliary device 22 is accommodated in the battery case 23 at a position in front of the battery 21, the case cover 40 may be flattened compared to a configuration in which an auxiliary device is disposed above a battery in a battery case, for example. Thus, a foot space of a passenger compartment may be enlarged.

Two seats 7L and 7R configured to allow passengers to sit and arranged in the left-right direction are mounted on the battery cover 40A. Each of the seats 7L and 7R is slidable in the front-rear direction, and is attached to the battery cover 40A via seat brackets 71 and seat rails 72 to be described later.

A console box 8 is mounted above the auxiliary device cover 40B. The console box 8 is attached to a central portion of the auxiliary device cover 40B in the left-right direction at a position in front of the seats 7L and 7R.

Next, the battery cover 40A will be described in detail.

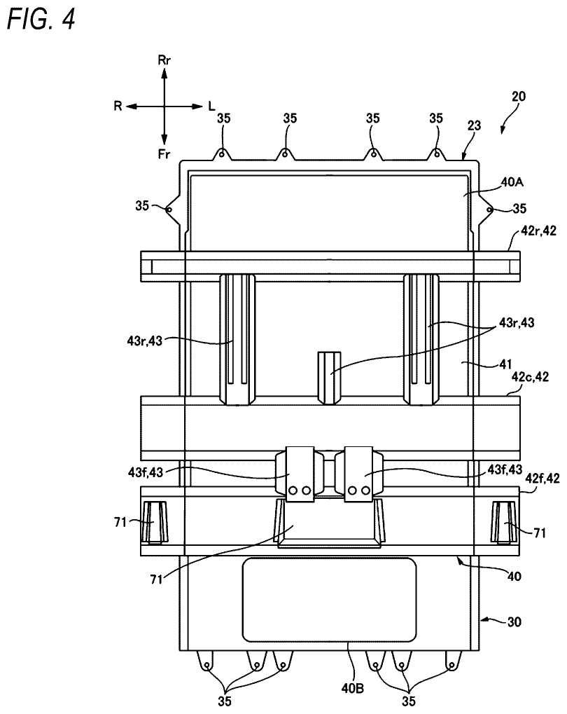

As shown in FIGS. 3 and 4, the battery cover 40A includes a plurality of cross member portions 42 extending in the left-right direction, and a plurality of frame portions 43 extending in the front-rear direction and intersecting the cross member portions 42.

The plurality of cross member portions 42 are integrally provided on the upper surface 41 of the battery cover 40A, and function as reinforcing portions that improve rigidity of the battery cover 40A.

In the present embodiment, three cross member portions 42 are provided, and include a front cross member portion 42f provided at a front portion of the battery cover 40A, a central cross member portion 42c provided at a central portion of the battery cover 40A, and a rear cross member portion 42r provided at a rear portion of the battery cover 40A. Each of the cross member portions 42 projects upward from the upper surface 41 of the battery cover 40A, and has a hat-shaped cross section taken along a plane orthogonal to the left-right direction. The number of the cross member portions 42 is not limited to three, and may be at least one.

The cross member portion 42 is configured such that both sides in the left-right direction protrude outward in the left-right direction from the upper surface 41 of the battery cover 40A. Such a portion protruding outward in the left-right direction (also referred to as a protruding portion) extends in the left-right direction above the side frame 5 in a state where the battery pack 20 is attached to the vehicle body frame 1. The protruding portion of the cross member portion 42 may be provided as a separate member from an inner portion of the cross member portion 42 in the left-right direction and joined by welding or the like, or may be provided integrally with the inner portion of the cross member portion 42 in the left-right direction.

The plurality of frame portions 43 are integrally provided on the upper surface 41 of the battery cover 40A. Similarly to the cross member portions 42, the frame portions 43 function as reinforcing portions that improve the rigidity of the battery cover 40A.

In the present embodiment, five frame portions 43 are provided, and include two front frame portions 43f provided between the front cross member portion 42f and the central cross member portion 42c, and three rear frame portions 43r provided between the central cross member portion 42c and the rear cross member portion 42r. Each of the frame portions 43 also projects upward from the upper surface 41 of the battery cover 40A.

The two front frame portions 43f are provided substantially at a center in the left-right direction, and extend to be connected to the front cross member portion 42f and the central cross member portion 42c. The front cross member portion 42f, the central cross member portion 42c, and the front frame portions 43f constitute a reinforcing portion having a substantially H shape in a top view, and further improve the rigidity of the battery cover 40A.

The three rear frame portions 43r are provided on a right side, a center, and a left side in the left-right direction, respectively, and the right and left rear frame portions 43r extend to be connected to the central cross member portion 42c and the rear cross member portion 42r.

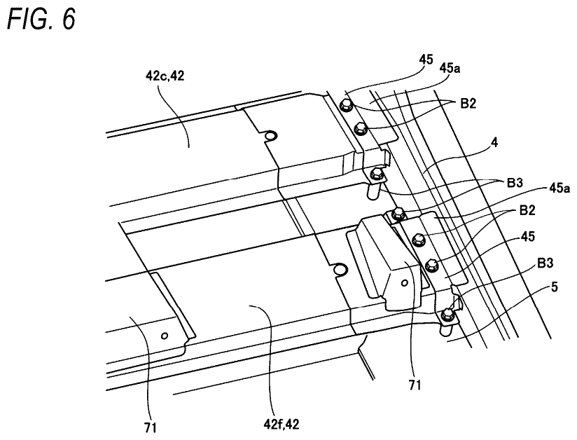

Next, fixing of the battery pack 20 to the vehicle body frame 1 will be described with reference to FIGS. 4 to 7.

As shown in FIG. 4, the case main body 30 includes a plurality of vehicle body fixing portions 35 at a front edge and a rear edge, and the battery pack 20 is fixed to the vehicle body frame 1 at the front edge and the rear edge by fastening the vehicle body fixing portions 35 to the vehicle body frame 1.

As shown in FIG. 7, a battery fixing bracket 36 is provided at a left edge of the case main body 30, and the case main body 30 is fixed to the left side frame 5 via the battery fixing bracket 36. An upper surface of the side frame 5 extends toward a battery pack 20 side, and a side frame fixing portion 37 directly fixed to the pair of side frames 5 is provided on a side wall of the case main body 30. A right edge of the case main body 30 and the right side frame 5 are also fixed in the same manner.

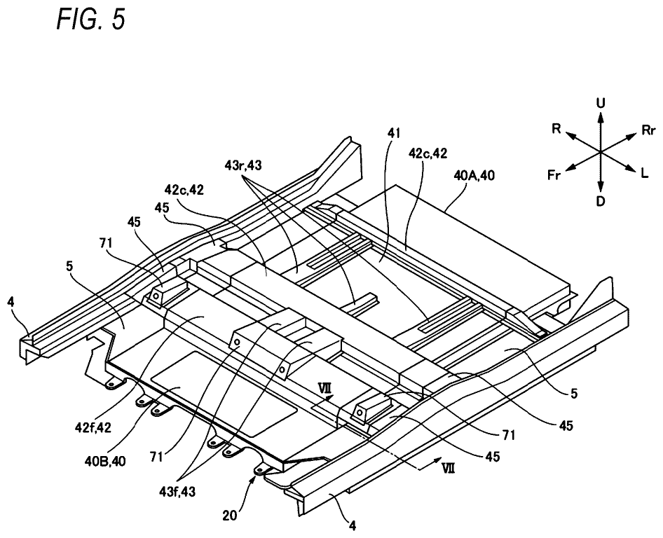

As shown in FIGS. 5 to 7, extension members 45 are provided at both ends (that is, the protruding portions) of the cross member portion 42 in the left-right direction. The extension member 45 extends in the left-right direction above the side frame 5. Similarly to the cross member portion 42, the extension member 45 also has a hat-shaped cross section. The extension member 45 covers both ends of the cross member portion 42 from above, and is attached to the cross member portion 42 via fastening members B2 such as bolts.

The extension member 45 and the side frame 5 are fixed by fastening members B3 such as bolts. More specifically, although the extension member 45 is provided apart from the side frame 5 in an upper-lower direction, the fastening member B3 is inserted through the extension member 45, the cross member portion 42, and the side frame 5 to fix the extension member 45, the cross member portion 42, and the side frame 5. In this way, both ends of the cross member portion 42 are fixed to the side frame 5 by the extension member 45. The cross member portion 42 is fixed to the side frame 5 by the extension member 45, and thus the rigidity of the battery cover 40A may be ensured.

Further, the extension member 45 and the side sill 4 are fixed to each other by, for example, spot welding. Specifically, the extension member 45 is fixed to the side sill 4 on an end 45a in the left-right direction. In this way, the cross member portion 42 is also fixed to the side sill 4 via the extension member 45. The cross member portion 42 extends in the left-right direction so as not to interfere with the side sill 4 when the battery pack 20 is attached to the opening 1a of the vehicle body frame 1 from below, and is fixed to the side sill 4 by the extension member 45, and thus the rigidity of the battery cover 40A may be ensured.

In this way, the battery pack 20 is fixed to the vehicle body frame 1 by the vehicle body fixing portion 35, the battery fixing bracket 36, and the side frame fixing portion 37 provided on the case main body 30, and the extension member 45 provided on the cross member portion 42.

The cross member portion 42 is fixed to the side sill 4 and the side frame 5 via the extension member 45, and thus a load input inward in the vehicle width direction from the side sill 4 and the side frame 5 at the time of a side collision of the vehicle V may be transmitted to the cross member portion 42, and the battery 21 accommodated in the battery case 23 may be protected.

As shown in FIG. 7, the cross member portion 42 faces the side sill 4 in the left-right direction. Accordingly, the load input inward in the vehicle width direction from the side sill 4 at the time of the side collision of the vehicle Vis satisfactorily transmitted to the cross member portion 42 without displacement.

Next, attachment of the seats 7L and 7R to the case cover 40 will be described.

As shown in FIG. 2, the seats 7L and 7R are mounted on the cross member portion 42 of the battery cover 40A. As described above, the cross member portion 42 is a portion having high rigidity that functions as a reinforcing portion, and thus the rigidity of the battery cover 40A may be sufficiently ensured against a load caused by weights of the seats 7L and 7R and weights of passengers seated on the seats 7L and 7R even in a structure in which the seats 7L and 7R are directly mounted on the battery cover 40A.

The seats 7L and 7R are mounted across the front cross member portion 42f and the central cross member portion 42c of the battery cover 40A. In this way, since the plurality of cross member portions 42 on which the seats 7L and 7R are mounted are provided, the rigidity of the battery cover 40A can be further improved against the load from the seats, and the battery cover 40A may stably support the seats 7L and 7R.

The seat rails 72 are provided on a right end and a left end of each of the seats 7L and 7R, and the seat rails 72 are installed between the front cross member portion 42f and the central cross member portion 42c. According to such a configuration, the seat rail 72 itself may also contribute to improvement in rigidity of the battery cover 40A.

The seat brackets 71 to which the seats 7L and 7R are attached are provided at both ends of the front cross member portion 42f in the left-right direction. A right front end of the right seat 7R and a left front end of the left seat 7L are fixed to the seat brackets 71 via the seat rails 72. A right rear end of the right seat 7R and a left rear end of the left seat 7L are fixed to both ends of the central cross member portion 42c in the left-right direction.

The seat bracket 71 is also provided at a central portion of the front cross member portion 42f in the left-right direction. A right front end of the left seat 7L and a left front end of the right seat 7R are fixed to the seat bracket 71 via the seat rails 72. A right rear end of the left seat 7L and a left rear end of the right seat 7R are fixed to a central portion of the central cross member portion 42c via the seat rails 72.

The extension member 45 fixed to the side frame 5 is a portion having high rigidity, and a part of each of the seats 7L and 7R is fixed in the vicinity of such a portion having high rigidity, and thus the battery pack 20 may support the seats 7L and 7R at the portions having high rigidity.

Since the seat bracket 71 is disposed above the side frame 5, the seats 7L and 7R are indirectly supported by the side frame 5, and the seats 7L and 7R may be supported by the battery cover 40A and the side frame 5.

Since the seat bracket 71 provided at the central portion of the front cross member portion 42f in the left-right direction is connected to the front frame portion 43f, the seats 7L and 7R may be supported at a portion having high rigidity even at a central portion in the vehicle width direction.

Although an embodiment of the present disclosure has been described above with reference to the accompanying drawings, it is needless to say that the present disclosure is not limited to the embodiment. It is apparent that those skilled in the art may conceive of various modifications and alterations within the scope described in the claims, and it is understood that such modifications and alterations naturally fall within the technical scope of the present disclosure. In addition, the components in the above embodiment may be freely combined without departing from the gist of the disclosure.

For example, in the above embodiment, the two seats 7L and 7R are mounted on the battery cover 40A, but the number of seats is not limited to two, and may be one or three or more.

In the present description, at least the following matters are described. In parentheses, corresponding components and the like in the above embodiment are shown as an example, but the present disclosure is not limited thereto.

(1) A vehicle (vehicle V) including:
a vehicle body frame (vehicle body frame 1); and
a battery pack (battery pack 20) including a battery (battery 21) and a battery case (battery case 23) in which the battery is accommodated and attached to the vehicle body frame, in which
the vehicle body frame includes a pair of side frames (side frame 5) extending along a front-rear direction of the vehicle and arranged on both sides in a left-right direction of the vehicle,
the battery pack is fixed to the pair of side frames,
the battery case includes
   a case main body on which the battery is disposed, and
   a battery cover (battery cover 40A) covering the case main body (case main body 30) from above and having an upper surface forming a floor panel of the vehicle, and
the battery cover is integrally provided with a cross member portion (cross member portion 42) extending in the left-right direction and having an upper portion on which a seat (seat 7L, 7R) configured to allow a passenger to sit on is mounted.

According to (1), since the upper surface of the battery cover constitutes the floor panel, it is not necessary to separately provide the floor panel, and a weight of the vehicle may be reduced. In a structure in which the seat is directly mounted on the battery cover constituting the floor panel, the cross member portion is integrally provided on the battery cover, and the seat is mounted on the cross member portion, and thus rigidity of the battery cover may be sufficiently ensured against a load from the seat.

(2) The vehicle according to claim 1, in which
the cross member portion includes a first cross member portion (front cross member portion 42f) and a second cross member portion (central cross member portion 42c) arranged in the front-rear direction, and
the seat is mounted across the first cross member portion and the second cross member portion.

According to (2), since the battery cover is provided with a plurality of cross member portions on which the seat is mounted, the rigidity of the battery cover may be further improved against the load from the seat.

(3) The vehicle according to (2), in which
a seat rail (seat rail 72) along which the seat is slidable is installed between the first cross member portion and the second cross member portion.

According to (3), the seat rail installed between the first cross member portion and the second cross member portion contributes to improvement in rigidity of the battery cover.

(4) The vehicle according to (2) or (3), in which
the battery cover is provided with a frame portion connected to the first cross member portion and the second cross member portion and extending in the front-rear direction, at a substantially central portion in the left-right direction.

According to (4), since the first cross member portion, the second cross member portion, and the frame portion constitute a reinforcing portion having an H shape in a top view, the rigidity of the battery cover may be further improved.

(5) The vehicle according to any one of (1) to (4), further including:
an extension member (extension member 45) fixed to each of the pair of side frames, in which
both ends of the cross member portion in the left-right direction are fixed to the pair of side frames by the extension members.

According to (5), the rigidity of the battery cover may be ensured by fixing the cross member portion to the side frame by the extension member.

(6) The vehicle according to (5), in which
seat brackets (seat bracket 71) to which the seat is attached are provided at the both ends of the cross member portion in the left-right direction.

According to (6), the extension member fixed to the side frame is a portion having high rigidity in the battery cover, and the seat bracket is provided in the vicinity of the portion having high rigidity, and thus the battery pack may support the seat at the portion having high rigidity.

(7) The vehicle according to (6), in which
the both ends of the cross member portion extend above the pair of side frames, and
the seat brackets are disposed above the pair of side frames.

According to (7), the load from the seat may also be supported by the side frame.

(8) The vehicle according to any one of (1) to (7), in which
the cross member portion is provided with a seat bracket (seat bracket 71) to which the seat is attached at a central portion in the left-right direction, and
the battery cover is provided with a frame portion (front frame portion 43f) extending in the front-rear direction and connected to the seat bracket.

According to (8), since the seat bracket is provided at a portion having high rigidity where the frame portion is provided, the battery pack may support the seat at the portion having high rigidity.

(9) The vehicle according to any one of (1) to (8), in which
the vehicle body frame further includes side sills (side sill 4) fixed to the pair of side frames, and
the cross member portion is fixed to the pair of side frames and the side sills via extension members (extension member 45) extending from both ends in the left-right direction.

According to (9), since the cross member portion is fixed to the side frame and the side sill via the extension member, the rigidity of the battery cover may be ensured. Thus, a load input from the side frame and the side sill at the time of a collision of the vehicle may be transmitted to the cross member portion, and the battery accommodated in the battery case may be protected.

(10) The vehicle according to any one of (1) to (9), in which
the vehicle body frame further includes side sills (side sill 4) fixed to the pair of side frames, and
the cross member portion faces the side sills in the left-right direction.

According to (10), at the time of the collision of the vehicle, the load input from the side sill may be satisfactorily transmitted to the cross member portion of the battery cover without displacement.

What is claimed is:

1. A vehicle comprising:
a vehicle body frame; and
a battery pack including a battery and a battery case in which the battery is accommodated and attached to the vehicle body frame, wherein
the vehicle body frame includes a pair of side frames extending along a front-rear direction of the vehicle and arranged on both sides in a left-right direction of the vehicle,
the battery pack is fixed to the pair of side frames,
the battery case includes
a case main body on which the battery is disposed, and
a battery cover covering the case main body from above and having an upper surface forming a floor panel of the vehicle, and
the battery cover is integrally provided with a cross member portion extending in the left-right direction and having an upper portion on which a seat configured to allow a passenger to sit on is mounted.

2. The vehicle according to claim 1, wherein
the cross member portion includes a first cross member portion and a second cross member portion arranged in the front-rear direction, and
the seat is mounted across the first cross member portion and the second cross member portion.

3. The vehicle according to claim 2, wherein
a seat rail along which the seat is slidable is installed between the first cross member portion and the second cross member portion.

4. The vehicle according to claim 2, wherein
the battery cover is provided with a frame portion connected to the first cross member portion and the second cross member portion and extending in the front-rear direction, at a substantially central portion in the left-right direction.

5. The vehicle according to claim 1, further comprising:
an extension member fixed to each of the pair of side frames, wherein
both ends of the cross member portion in the left-right direction are fixed to the pair of side frames by the extension members.

6. The vehicle according to claim 5, wherein
seat brackets to which the seat is attached are provided at the both ends of the cross member portion in the left-right direction.

7. The vehicle according to claim 6, wherein
the both ends of the cross member portion extend above the pair of side frames, and
the seat brackets are disposed above the pair of side frames.

8. The vehicle according to claim 1, wherein
the cross member portion is provided with a seat bracket to which the seat is attached at a central portion in the left-right direction, and
the battery cover is provided with a frame portion extending in the front-rear direction and connected to the seat bracket.

9. The vehicle according to claim 1, wherein
the vehicle body frame further includes side sills fixed to the pair of side frames, and
the cross member portion is fixed to the pair of side frames and the side sills via extension members extending from both ends in the left-right direction.

10. The vehicle according to claim 1, wherein
the vehicle body frame further includes side sills fixed to the pair of side frames, and
the cross member portion faces the side sills in the left-right direction.
